(19) United States
(12) Patent Application Publication
(10) Pub. No.: US 2012/0189072 A1
(43) Pub. Date: Jul. 26, 2012

(54) COMBINED DATA AND PROBE (CDP) FRAME

(75) Inventors: Marcos C. Tzannes, Orinda, CA (US); Joon Bae Kim, Lexington, MA (US)

(73) Assignee: AWARE, INC., Bedford, MA (US)

(21) Appl. No.: 13/383,872

(22) PCT Filed: Jul. 19, 2010
(86) PCT No.: PCT/US10/42461

§ 371 Date: Mar. 23, 2012

Related U.S. Application Data
(60) Provisional application No. 61/226,320, filed on Jul. 17, 2009.

(51) Int. Cl. H04L 27/28

(52) U.S. Cl. 375/260

(57) ABSTRACT

A system or method in an OFDM communication environment includes transmitting, by a transmitter, and/or receiving, by a receiver, a frame that includes one or more preamble symbols, one or more header symbols, a plurality of data symbols, and a plurality of probe symbols. The probe symbols are predefined symbols that do not carry user data and are generated by modulating a predefined pseudo-random bit sequence (PRBS). A frame header, communicated in the one or more header symbols, includes one or more bit fields that indicate that the frame includes N probe symbols, wherein N is an integer greater than 1, and wherein the plurality of probe symbols are transmitted or received after the one or more header symbols and before the plurality of data symbols.

### RELATED APPLICATION DATA

This application claims the benefit of and priority under 35 U.S.C. §119(e) to U.S. patent application Ser. No. 61/226,320, filed Jul. 17, 2009, entitled “Combined Data and Probe Frame,” which is incorporated herein by reference in its entirety.

### FIELD OF THE INVENTION

An exemplary aspect of this invention relates to communications systems. More specifically, exemplary methods, systems, means, protocols and computer-readable storage media, are directed toward improved channel probing in frame-based or packet-based transmission systems.

### BACKGROUND

Conventional multi-user communication systems use frame-based (or packet-based) transmission to communicate between two or more users over a shared channel based on OFDM. Examples of such systems include IEEE 802.11x (Wireless LAN), IEEE 802.16 (WiMAX) and ITU G.9960 (G.hn). These systems use OFDM transmission (also referred to sometimes as Discrete MultiTone (DMT)) which divides the transmission frequency band into multiple sub-carriers (also referred to as tones or sub-channels), with each sub-carrier individually modulating a bit or a collection of bits.

Conventional methods for channel probing in frame-based transmission systems are described in the current G.hn ITU Standard (incorporated herein by reference). This draft standard describes a channel probing procedure that addresses measuring the characteristics of the channel between the transmitter (source) and the receiver (destination) nodes. This procedure involves initiation of channel estimation, transmissions of probe frames, and selection of parameters, which includes bit allocation table (BAT), guard interval for a payload, length of the probe frame, and PSD (Power Spectral Density) ceiling. The same protocol is used for initial channel estimation and dynamic channel adaptation, but with different initiation schemes.

The G.hn ITU Standard procedure is described as follows:
The channel estimation procedure is divided into two categories:
   Channel discovery—initial channel estimation when no valid BAT is available
   Channel adaptation—subsequent channel estimation to adapt changing channel
The channel estimation procedure is designed for unicast transmission. The same mechanism can be used for multicast transmission with slight modification.

The transmitter, the receiver(s), and the domain master can initiate this process. Channel estimation is typically initiated by the receiver. Transmitter initiation may be useful for multicast or for the beginning of a communication where no valid BAT is available. Domain master initiation may be useful for bandwidth (e.g., TXOP) reallocation.

The receiver may request the transmitter to send a probe frame. The receiver can select different parameters each time—guard interval, PSD ceiling (i.e., the maximum PSD level), length of probe frame.

The transmitter transmits Probe frames as the receiver requested.

The above two procedures can repeat until the receiver sends the transmitter the final outcome of the channel estimation. The receiver may send the channel estimation results without requesting Probe frames in case it uses other means (e.g., regular data frames) for channel estimation.

In a multicast case, based on channel estimation results collected from multiple receivers, the transmitter selects parameters at its own discretion, and broadcast the final outcome to all members.

Instead of the message, a probe frame is used to exchange channel estimation control information between the transmitter and the receiver. This is to reduce the overhead caused by exchanging short messages, and to speed up the channel estimation process.

Appendix A, below, contains the draft text for the Channel Estimation Protocol from the current G.hn ITU Draft Standard.

### SUMMARY

A first exemplary aspect is at least directed toward one or more of methods, systems, means, protocols and computer-readable storage media with computer (processor) executable instructions for improved channel probing in frame-based or packet-based transmission systems.

Channel probing is used by receivers and transmitters for a number of reasons including, but not limited to, measuring the channel characteristics, channel estimation, selection of parameters such as BAT, guard interval (also known as cyclic prefix), PSD ceiling, FEC coding rate and/or codeword size, etc. This improved channel probing uses a new frame format in which a frame contains both data symbols and probe symbols. These new frames, which will be referred to for convenience as Combined Data and Probe (CDP) frames, can be used to communicate data bits while also performing channel probing.

FIG. 1 shows a conventional data frame, which contains one or more preamble symbols, one or more header symbols and one or more data symbols. The data symbols are used to communicate data bits from the transmitter to the receiver.

FIG. 2 shows a conventional probe frame, which contains one or more preamble symbols, one or more header symbols and one or more probe symbols. The probe symbols are predefined symbols that do not carry data and can be used by the receiver and/or transmitted for channel probing. In one exemplary embodiment, the probe symbols are generated by modulating a predefined pseudo-random bit sequence (PRBS). For example, a plurality of sub-carriers of the probe symbol can be modulated by a predefined PRBS that is known by the transmitter and/or the receiver.

FIG. 3 to FIG. 6 show examples of CDP frames. In these examples the “format” of the CDP frame indicates, at least, the location of the probe symbol(s) in the frame. FIG. 3 shows an example of a CDP frame. This exemplary CDP frame contains one or more preamble symbols, one or more header symbols and one or more data symbols followed by one or probe symbols. In this CDP frame format the probe symbols are transmitter and/or received after the data symbols. The data symbols can be used to communicate data bits while the Probe symbols can be used for channel probing.

FIG. 4 shows another example of a CDP frame. This exemplary CDP frame contains one or more preamble symbols, one or more header symbols and one or more probe symbols followed by one or data symbols. In this CDP frame format the probe symbols are transmitter and/or received before the data symbols. The data symbols can be used to communicate data bits while the probe symbols can be used for channel probing.

FIG. 5 shows another example of a CDP frame. This exemplary CDP frame contains one or more preamble symbols, one or more header symbols and one or more data symbols followed by one or probe symbols followed by one or more data symbols followed by one or more probe symbols. In this CDP frame format the probe symbols are transmitter and/or received after the data symbols and this pattern is repeated at least one more time. The data symbols can be used to communicate data bits while the probe symbols can be used for channel probing. While this example shows two repetitions of data symbols and probe symbols, any number of repetitions is possible. For example, there could be N data symbols followed by M probe symbols for K repetitions, where N, M and K are integers greater than zero and/or greater than 1.

FIG. 6 shows another example of a CDP frame. This exemplary CDP frame contains one or more preamble symbols, one or more header symbols and one or more probe symbols followed by one or data symbols followed by one or more probe symbols followed by one or more data symbols. In this CDP frame format the probe symbols are transmitter and/or received before the data symbols and this pattern is repeated at least one more time. The data symbols can be used to communicate data bits while the probe symbols can be used for channel probing. While this example shows two repetitions of probe symbols and data symbols, any number of repetitions is possible. For example, there could be M probe symbols followed by N data symbols for K repetitions, where M, N and K are integers greater than zero and/or greater than 1.

According to one exemplary embodiment, information regarding the CDP frame is communicated in the header portion of the frame, i.e., in the header symbols.

For example the header could contain one or more bit fields that indicate that the CDP frame contains N Probe symbols, where N is an integer greater than zero. Alternatively, for example, the header could contain one or more bit fields that indicate that the CDP frame contains N Probe symbols, where N is an integer greater than one.

Alternatively, or in addition, the header could contain one or more bit fields that indicate the CDP frame format. For example, the bit field could indicate whether the probe symbols are after the data symbols (as shown in the CDP frame example of FIG. 3) or before the data symbols (as shown in the CDP frame example of FIG. 4).

Alternatively, or in addition, the header could contain one or more bit fields that indicate that the CDP frame contains N data symbols, where N is an integer greater than zero.

Alternatively, or in addition, the header could contain one or more bit fields that indicate whether the data symbols are after the probe symbols (as shown in the CDP frame example of FIG. 4) or before the probe symbols (as shown in the CDP frame example of FIG. 3).

Alternatively, or in addition, the header could contain one or more bit fields that indicate that the CDP frame contains N data symbols followed by (or preceding) M probe symbols for a number of K repetitions, where N, M and K are integers greater than zero (as shown in the CDP examples in FIG. 5 and FIG. 6).

This information could be communicated in the header in a number of ways. For example, the header could contain the one or more of the values for M and/or N and/or K as described in the alternative examples above. Alternatively, or in addition, for example, the header format of a normal data frame may be used to define the number of data symbols in a CDP frame and/or the header would additionally contain an integer value N, that indicates that there is one or more probe symbol after every Nth data symbol. In addition, for example, the number one or more probe frames, e.g., an integer number L, after every N-th data symbol may be indicated in the header.

Transmission parameters used data symbols versus probe symbols.

In one exemplary embodiment, the data symbols and the probe symbols in a CDP frame use at least one different communication parameter. This enables performing channel probing using different transmission parameters than those used for data transmission. For example, the data symbols and the probe symbols in a CDP frame may use different guard intervals. Alternatively, or in addition, at least one data symbol and at least one probe symbol in a CDP frame may use different PSD ceiling values. Alternatively, or in addition, at least one data symbol and at least one probe symbol in a CDP frame may use different BATs. Alternatively, or in addition, at least one data symbol and at least one probe symbol in a CDP frame may use different FEC (Forward Error Correction) coding rate and/or codeword size.

Alternatively, or in addition, probe symbols in a CDP frame may use different transmission parameters. For example, at least one probe symbol may have a different transmission parameter than at least one other probe symbol. For example, at least one probe symbol and at least one other probe symbol in a CDP frame may use different guard intervals. Alternatively, or in addition, at least one probe symbol and at least one other probe symbol in a CDP frame may use different PSD ceiling values. Alternatively, or in addition, at least one probe symbol and at least one other probe symbol in a CDP frame may use different BATs. Alternatively, or in addition, at least one probe symbol and at least one other probe symbol in a CDP frame may use a different FEC coding rate and/or codeword size.

For example, a first number of data symbols in a CDP frame may use a first guard interval and a second number of probe symbols in the CDP frame may use a second guard interval. It should be noted that the first and/or second guard interval could have zero samples, which means that in this case the data and/or probe symbols would not have any guard interval, i.e., guard interval length=0. Alternatively, or in addition, a first number of data symbols in a CDP frame may use a first PSD ceiling value and a second number of probe symbols in the CDP frame may use a second PSD ceiling value. Alternatively, or in addition, a first number of data symbols in a CDP frame may use a first BAT and a second number of probe symbols in the CDP frame may use a second BAT. Alternatively, or in addition, a first number of data symbols in a CDP frame may use a first FEC coding rate and/or codeword size and a second number of probe symbols in the CDP frame may use a second FEC coding rate and/or codeword size.

Alternatively, or in addition, a first number of probe symbols in a CDP frame may use different communication parameter(s) from a second number of probe symbols. For example, a first number of probe symbols in a CDP frame may use a first guard interval and a second number of probe symbols in the CDP frame may use a second guard interval. It should be noted that the first and/or second guard interval could have zero samples, which means that in this case the first and/or second number of probe symbols would not have any guard interval, i.e., guard interval length=0. Alternatively, or in addition, a first number of probe symbols in a CDP frame may use a first PSD ceiling value and a second number of probe symbols in the CDP frame may use a second PSD ceiling value. Alternatively, or in addition, a first number of probe symbols in a CDP frame may use a first BAT and a second number of Probe symbols in the CDP frame may use a second BAT. Alternatively, or in addition, a first number of probe symbols in a CDP frame may use a first FEC coding rate and/or codeword size and a second number of probe symbols in the CDP frame may use a second FEC coding rate and/or codeword size.

Alternatively, or in addition, at least two probe symbols may use the same PRBS for sub-carrier modulation. For example, a first probe symbol may use a PRBS that is the same as a second probe symbol (resulting in a periodic signal). Alternatively, or in addition, the first and second probe symbols may not use a guard interval (Guard interval length=0), resulting in a periodic signal that is comprised of pure sinusoids. These types of signal are useful for receiver processing and training, such as time equalizer training and/or frequency domain equalizer training and/or SNR measurement without inter-symbol interference, etc.

Alternatively, or in addition, a first number of probe symbols in a CDP frame may use the same phase modulation (e.g., to achieve periodic OFDM symbols with, for example, Guard interval length=0) and a second number of probe symbols in the CDP frame may use different phase modulation (e.g., to achieve Pseudo-randomly modulated OFDM symbols), or vice versa.

For example, a first number of probe symbols in a CDP frame may use a same PRBS (e.g., to achieve periodic OFDM symbols with, for example, Guard interval length=0) and a second number of probe symbols in the CDP frame may use different PRBS (e.g., to achieve Pseudo-randomly modulated OFDM symbols), or vice versa.

Exemplary Protocol for requesting a CDP frame

In one exemplary embodiment the following protocol is used:

1. A receiver requests a CDP frame to be transmitted by a transmitter. A CDP frame request may be done in a number of ways. For example the receiver could request the transmission of a CDP frame by transmitting to the transmitter any available frame type (e.g., probe, data, ACK, ACK+MSG, MSG frames, etc) prior to the transmission of the CDP frame. The CDP frame request could, for example, be indicated in a bit field in the header of a frame transmitted by the receiver to the transmitter prior to the transmission of the CDP frame. Alternatively or in addition, the CDP frame request could be transmitted by the receiver in the information field of a separate management message frame(s) prior to the transmission of the CDP frame.

2. Alternatively, or in addition, the CDP frame request transmitted by the receiver may indicate the CDP frame format and/or number of probe symbols of the CDP frame. For example, the CDP frame request could indicate the format and/or number of probe symbols of the CDP frame using any of the methods described herein and/or shown in FIGS. 3, 4, 5, and 6. The CPD frame request could be done using any of the methods described in step 1.

3. Alternatively, or in addition, the CDP frame request transmitted by the receiver may indicate a value for at least one communication parameter used for the probe symbols in the CDP frame. For example, the CDP frame request could indicate a value for a guard interval and/or a PSD ceiling and/or BAT and/or FEC coding rate and/or codeword size to be used for transmission of the probe symbols in the CDP frame. The CPD frame request could be done using any of the methods described in step 1.

4. Alternatively, or in addition, the CDP frame request transmitted by the receiver may request a CDP frame where the data symbols and the probe symbols use at least one different communication parameter. For example, the CDP frame request could indicate a first value for a guard interval and/or a first value for a PSD ceiling and/or a first set of values for a BAT and/or a first value for an FEC coding rate and/or a first value for a codeword size to be used for the data symbols of the CDP frame. The CDP frame request could also indicate a second value for a guard interval and/or a second value for a PSD ceiling and/or a second set of values for a BAT and/or a second value for an FEC coding rate and/or a second value for a codeword size to be used for the probe symbols of the CDP frame. At least one of the first values could be different than at least one of the second values. T he CPD frame request could be done using any of the methods described in step 1.

5. Upon receipt (or soon thereafter) of the CDP frame request from the receiver, the transmitter transmits a CDP frame. The CDP frame transmitted by the transmitter could be based one or more of the alternate CDP frame requests described in Steps 2, 3 and 4. For example, based on the CDP frame request, the transmitted CDP frame could use a format and/or number probe symbols using any of the methods described herein and/or shown in FIGS. 3, 4, 5, and 6.

6. Alternatively, or in addition, based on the CDP frame request, the transmitted CDP frame could use a value for a guard interval and/or a PSD ceiling and/or BAT and/or FEC coding rate and/or codeword size for the probe symbols.

7. Alternatively, or in addition, based on the CDP frame request, the transmitted CDP frame could use a first value for a guard interval and/or a first value for a PSD ceiling and/or first set of values for a BAT and/or first value for an FEC coding rate and/or a first value for a codeword size for the data symbols and the transmitted CDP frame could use a second value for a guard interval and/or a second value for a PSD ceiling and/or second set of values for a BAT and/or second value for an FEC coding rate and/or second value for a codeword size for the probe symbols. At least one of the first values could be different than at least one of the second values.

8. Alternatively, or in addition, the CDP frame transmitted by the transmitter could indicate in the CDP frame header the format and/or number of probe symbols contained in the CDP frame. The header could indicate the format and/or number of probe symbols contained in the CDP frame using any of the methods described herein.

9. Alternatively, or in addition, the CDP frame transmitted by the transmitter could indicate in the CDP frame header at least one transmission parameter used for the probe symbols in the CDP frame. For example, the CDP frame header could indicate a value for a guard interval and/or a PSD ceiling and/or BAT and/or FEC coding rate and/or codeword size for the probe symbols.

10. Alternatively or in addition, the CDP frame transmitted by the transmitter could indicate in the CDP frame header at least one transmission parameter used for a set of data symbols in the CDP frame and at least one transmission parameter used for a set of probe symbols in the CDP frame. For example, the CDP frame header could indicate a first value for a guard interval and/or a first value for a PSD ceiling and/or a first set of values for a BAT and/or a first value for an FEC coding rate and/or a first value for a codeword size for the set of data symbols. The CDP frame header could also indicate a second value for a guard interval and/or a second value for a PSD ceiling and/or second set of values for a BAT and/or a second value for an FEC coding rate and/or a second value for a codeword size for the set of probe symbols. At least one of the first values could be different than at least one of the second values.

11. The receiver receives the probe frame transmitted by the transmitter. The receiver decodes the data symbols and may use the probe symbols for channel probing. The receiver may decode the header to determine information about the data symbols and probe symbols in the CDP frame. For example, the receiver may decode the header to determine the format and/or number of probe symbols contained in the CDP frame.

12. Alternatively, or in addition, the receiver may decode the header to determine the value for the guard interval and/or a PSD ceiling and/or BAT and/or FEC coding rate and/or codeword size for the probe symbols in the CDP frame.

13. Alternatively, or in addition, the receiver may decode the header to determine the first value for a guard interval and/or first value for a PSD ceiling and/or first set of values for a BAT and/or first value for an FEC coding rate and/or first value for a codeword size for the set of data symbols. The receiver may decode the header to determine the second value for a guard interval and/or a second value for a PSD ceiling and/or second set of values for a BAT and/or second value for an FEC coding rate and/or second value for a codeword size for the set of probe symbols. At least one of the first values could be different than at least one of the second values.

Exemplary Benefits of Using CDP Frames

Faster Channel Estimation with Better Efficiency

Transmitting a separate probe frame requires the usual overhead—inter-frame gap (IFG), preamble, and header (see FIG. 7). This overhead can be quite significant in a power line medium since: (1) channel adaptation is executed frequently to cope with a rapidly changing channel, (2) the length of probe frame should be relatively short to achieve better MAC (Media Access Controller) efficiency, and (3) MAC efficiency degrades even further as the number of active users (i.e., the number of total probe frame transmissions) increases.

If probe symbols can be transmitted along with data symbols as described herein, this overhead can be removed entirely, hence improving both speed and efficiency of channel estimation (see FIG. 8). Since additional probe symbols are inserted and extracted at the PMD layer, the upper-layer processing such as framing and retransmission won't be affected.

Reduced Receiver Complexity

In order to optimize MAC efficiency, various types of IFG may be introduced to address different cases (e.g., regular frame separation, RTS/CTS, ACK, etc), and very aggressive values can be selected for these parameters. This can increase receiver complexity significantly for a low-end device. If one or more probe symbols are added at the end of data symbols, the receiver can meet the aggressive IFG without increasing the receiver complexity because appended the probe symbols can be treated as dummy symbols that do not need to be processed (see FIG. 9).

Predictable Interference Mitigation

There exists predictable interferences in systems. Examples of such impediments include a periodic impulse noise, transmissions from a neighbor's domain, etc. Probe symbols in a CDP frame can also be used to protect data symbols, and may be treated as dummy symbols (See FIG. 10).

Exemplary aspects of the invention are thus directed toward:

1. A method in an OFDM communication system comprising:
transmitting, by a transmitter, and/or receiving, by a receiver, a frame comprising:
one or more preamble symbols;
one or more header symbols;
one or more data symbols; and
and one or more probe symbols.

2. An OFDM communication system comprising:
means for transmitting and/or a means for receiving a frame comprising:
one or more preamble symbols;
one or more header symbols;
one or more data symbols; and
and one or more probe symbols.

3. An OFDM communication system comprising:
a transmitter capable of transmitting and/or a receiver capable of receiving a frame comprising:
one or more preamble symbols;
one or more header symbols;
one or more data symbols; and
and one or more probe symbols.

4. A non-transitory computer-readable media having stored thereon instructions that, if executed by a processor, are for OFDM communication comprising:
instructions that generate a frame for transmission or instructions that process a frame after reception, the frame comprising:
one or more preamble symbols;
one or more header symbols;
one or more data symbols; and
and one or more probe symbols.

5. Any one or more of aspects 1-4, wherein the one or more probe symbols are transmitted or received after the one or more data symbols.

6. Any one or more of aspects 1-5, wherein the one or more data symbols are transmitted or received after the one or more probe symbols.

7. Any one or more of aspects 1-6, wherein at least one data symbol uses a different communication parameter value than at least one probe symbol.

8. Any one or more of aspects 1-7, wherein at least one data symbol uses a first guard interval value and at least one probe symbol uses a second, different, guard interval value.

9. Any one or more of aspects 1-8, wherein at least one data symbol uses a first PSD ceiling value and at least one probe symbol uses a second, different, PSD ceiling value.

10. Any one or more of aspects 1-9, wherein at least one data symbol uses a first bit allocation table and at least one probe symbol uses a second, different, bit allocation table.

11. Any one or more of aspects 1-10, wherein a frame header contains one or more bit fields that indicate that the frame contains one or more data symbols and one or more probe symbols.

12. Any one or more of aspects 1-11, wherein a frame header contains one or more bit fields that indicate that the frame contains N probe symbols, wherein N is an integer.

13. Any one or more of aspects 1-12, wherein a frame header contains one or more bit fields that indicate that the frame contains N probe symbols, wherein N is an integer and M data symbols, where M is an integer.

14. Any one or more of aspects 1-13, wherein a frame header contains one or more bit fields that indicate that the probe symbols are transmitted or received after the data symbols.

15. Any one or more of aspects 1-14, wherein a frame header contains one or more bit fields that indicate that the probe symbols are transmitted or received before the data symbols.

16. Any one or more of aspects 1-15, wherein a frame header contains one or more bit fields that indicate that there are N data symbols followed by (or preceding) M probe symbols for a number of K repetitions, where N, M and K are integers.

17. Any one or more of aspects 1-16, wherein a frame header contains one or more bit fields that indicate that there is one or more probe symbol after every Nth data symbol, where N is an integer

18. Any one or more of aspects 1-17, wherein at least one probe symbol uses a different communication parameter value than at least one other probe symbol.

19. Any one or more of aspects 1-4, wherein at least one probe symbol uses a first guard interval value and at least one other probe symbol uses a second, different, guard interval value.

20. Any one or more of aspects 1-4, wherein at least one probe symbol uses a first PSD ceiling value and at least one other probe symbol uses a second, different, PSD ceiling value.

21. Any one or more of aspects 1-4, wherein at least one probe symbol uses a first bit allocation table and at least other probe symbol uses a second, different, bit allocation table.

22. Any one or more of aspects 1-4, wherein at least one probe symbol uses one PRBS and at least other probe symbol uses a second, different, PRBS.

23. Any one or more of aspects 1-4, wherein at least two probe symbols use the same PRBS resulting in a periodic signal.

24. Any one or more of aspects 1-4, wherein at least two probe symbols use the same PRBS without a guard interval resulting in a periodic signal comprised of pure sinusoids.

25. A system or method in an OFDM communication environment comprising:
transmitting, by a transmitter, and/or receiving, by a receiver, a frame comprising:
   one or more preamble symbols;
   one or more header symbols;
   a plurality of data symbols; and
   a plurality of probe symbols, wherein the probe symbols are predefined symbols that do not carry user data and are generated by modulating a predefined pseudo-random bit sequence (PRBS),
wherein a frame header, communicated in the one or more header symbols, includes one or more bit fields that indicate that the frame includes N probe symbols, wherein N is an integer greater than 1, and
wherein the plurality of probe symbols are transmitted or received after the one or more header symbols and before the plurality of data symbols.

Any of the above aspects and further aspects may be located in a network management system or network operation device that is located inside or outside the network and/or the transceiver(s). In particular, aspects that are related to determining a construct of the CDP frame may be done in such a device. The network operation or management device that is located inside or outside the network may be managed and/or operated by a user, consumer, service provider or power utility provider or a governmental entity.

These and other features and advantages of this invention are described in, or are apparent from, the following detailed description of the exemplary embodiments.

### BRIEF DESCRIPTION OF THE DRAWINGS

The exemplary embodiments of the invention will be described in detail, with reference to the following figures, wherein:

FIG. 1 illustrates an exemplary data frame;

FIG. 2 illustrates an exemplary probe frame;

FIG. 3 illustrates an exemplary CDP frame;

FIG. 4 illustrates an exemplary CDP frame;

FIG. 5 illustrates an exemplary CDP frame;

FIG. 6 illustrates an exemplary CDP frame;

FIG. 7 illustrates inter-frame gap;

FIG. 8 illustrates inter-frame gap;

FIG. 9 illustrates a dummy symbol;

FIG. 10 illustrates interference mitigation;

FIG. 11 illustrates message and CDP exchange;

FIG. 12 illustrates message and CDP exchange;

FIG. 13 illustrates an exemplary transceiver;

FIG. 14 is a flowchart illustrating an exemplary method for determining and using CDP frames;

FIG. 15 is a flowchart illustrating another exemplary method for determining and using CDP frames;

FIG. 16 is a flowchart illustrating another exemplary method for determining and using CDP frames;

FIG. 17 is a flowchart illustrating another exemplary method for determining and using CDP frames; and

FIG. 18 is a flowchart illustrating an exemplary method for transmitting CDP frame(s).

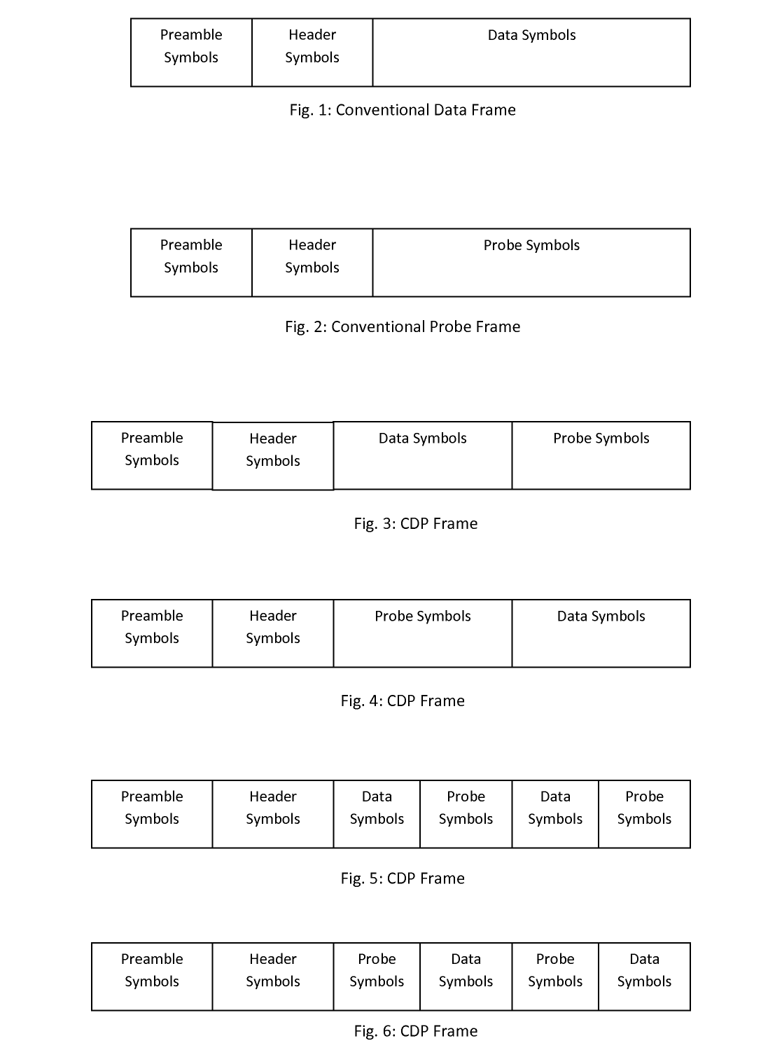

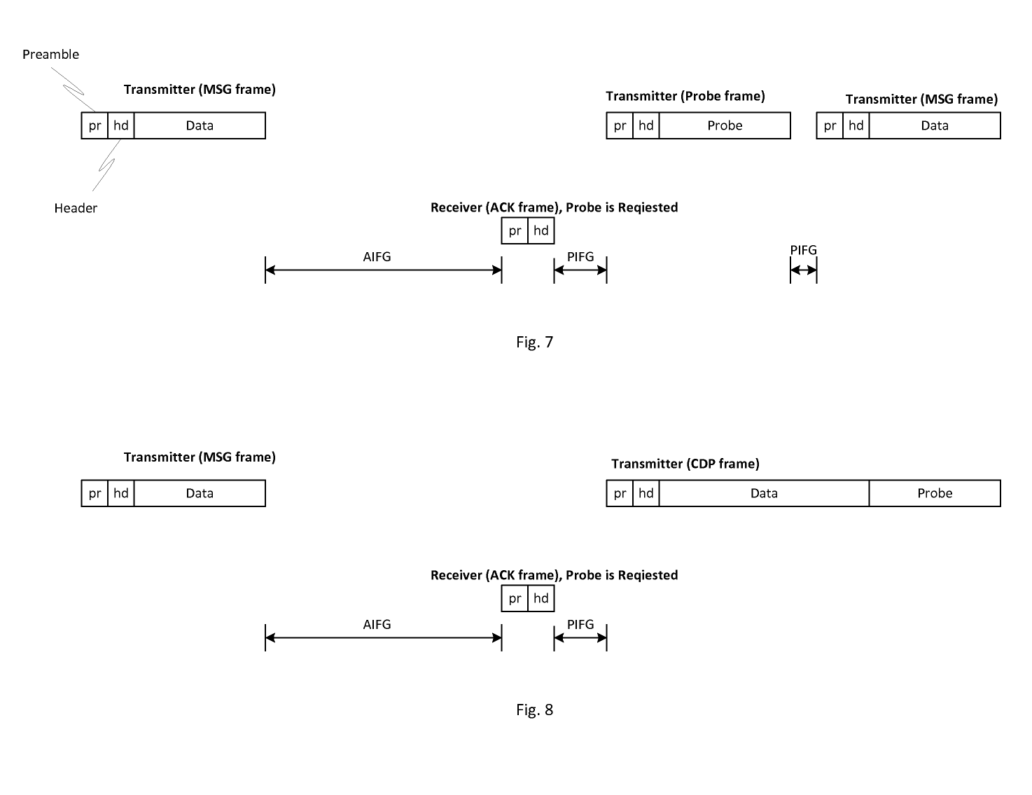

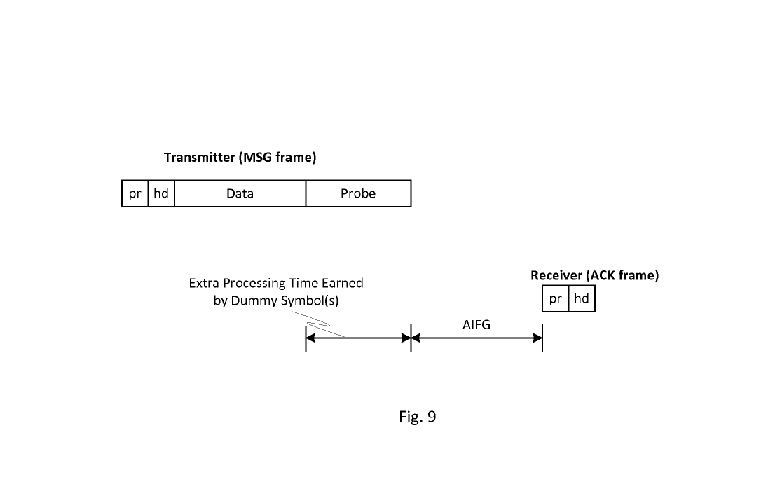

### DETAILED DESCRIPTION

The exemplary embodiments of this invention will be described in relation to communications systems, as well as protocols, techniques and methods for determining and using CDP frame(s) in a home network or an access network, or in general any communications network operating using any communications protocol(s). Examples of such home or access networks include home powerline networks, access powerline networks, home coaxial cable network, access coaxial cable network, home telephone networks, wireless LAN networks, wireless WAN networks and access telephone networks. However, it should be appreciated that in general, the systems, methods, and techniques of this invention will work equally well for other types of communications environments, networks and/or protocols.

The exemplary systems and methods of this invention will also be described in relation to wired or wireless modems and/or a software and/or a hardware testing module, a telecommunications test device, or the like, a line card, a G.hn transceiver, a MOCA transceiver, a Homeplug® transceiver, a power line modem, a wired or wireless modem, test equipment, a multicarrier transceiver, a wireless wide/local area network system, a satellite communications system, a network-based communications systems, such as an IP, Ethernet or ATM system, a modem equipped with diagnostic capabilities, or the like, or a separate programmed general purpose computer having a communications device that is capable of operating in conjunction with any one or more of the following communications protocols: MOCA, G.hn, Homeplug, 802.11, 802.11x, 802.15, 802.16, or the like. However, to avoid unnecessarily obscuring the present invention, the following description omits well-known structures, operations and devices that may be shown in block diagram form or are otherwise summarized or known.

For purposes of explanation, numerous details are set forth in order to provide a thorough understanding of the present invention. It should be appreciated however that the present invention may be practiced in a variety of ways beyond the specific details set forth herein. Furthermore, while the exemplary embodiments illustrated herein show various components of this system collocated, it is to be appreciated that the various components of the system can be located at distant portions of a distributed network, such as a communications network, node, within a Domain Master, and/or the internet, or within a dedicated secured, unsecured, and/or encrypted system and/or within a network operation or management device that is located inside or outside the network. As an example, a Domain Master can also be used to refer to any device, system or module that manages and/or configures any one or more aspects of the network or communications environment.

Thus, it should be appreciated that the components of the system can be combined into one or more devices, or split between devices, such as a modem, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, or some combination thereof. Similarly, one or more of the functional portions of the system could be distributed between a modem and an associated computing device/system, and/or in a dedicated test and/or measurement device.

Furthermore, it should be appreciated that the various links 5, including the communications channel(s) connecting the elements can be wired or wireless links or any combination thereof, or any other known or later developed element(s) capable of supplying and/or communicating data to and from the connected elements. The term module as used herein can refer to any known or later developed hardware, software, firmware, or combination thereof, that is capable of performing the functionality associated with that element. The terms determine, calculate, and compute and variations thereof, as used herein are used interchangeable and include any type of methodology, process, technique, mathematical operational or protocol. The terms transceiver and modem are also used interchangeably herein. The terms transmitting modem and transmitting transceiver as well as receiving modem and receiving transceiver are also used interchangeably herein.

The term management interface is related to any type of interface between a management entity and/or technician and a transceiver, such as, a CO-MIB or CPE-MIB as described, for example, in ITU standard G.997.1, which is incorporated herein by reference in its entirety.

Moreover, while some of the exemplary embodiments described herein are directed toward a transmitter portion of a transceiver performing certain functions, this disclosure is intended to include corresponding receiver-side functionality in both the same transceiver and/or another transceiver, and vice versa.

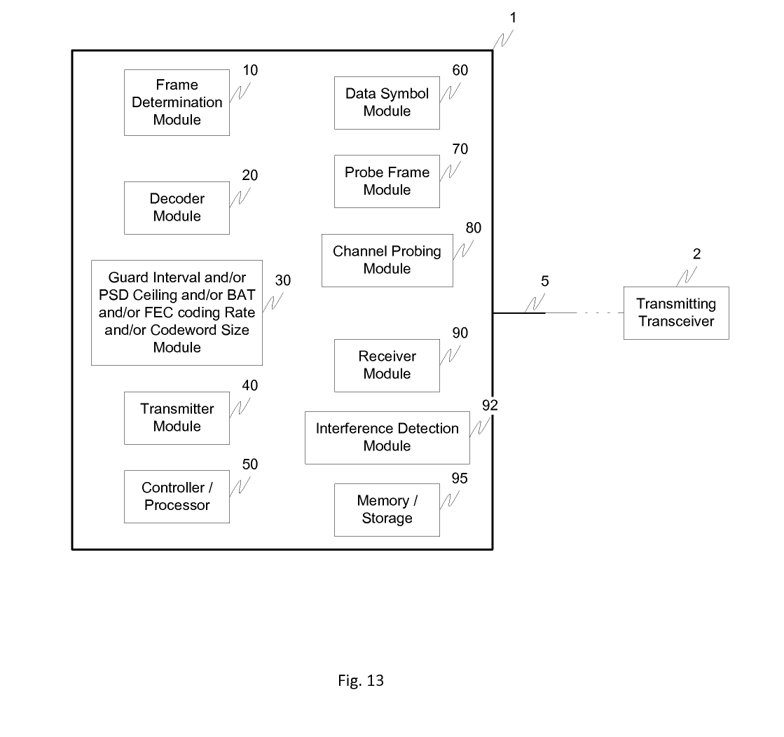

FIG. 13 illustrates an exemplary communications system with transceiver 1 and transceiver 2. In addition to well known and common componentry, the transceiver 1 includes a frame determination module 10, decoder module 20, guard interval and/or PSD ceiling and/or BAT and/or FEC coding rate and/or codeword size module 30, transmitter module 40, controller/processor 50, data symbol module 60, probe frame module 70, channel probing module 80, receiver module 90, and memory/storage 95. The transceiver 1 is capable communicating with one or more other transceivers, such as transceiver 2 that can include comparable componentry as transceiver 1, via communications link 5.

In operation, a CDP frame request is sent from a receiving transceiver 1 to transmitting transceiver 2. As discussed, this CDP frame request can include information regarding the format and/or number of probe symbols to be included in the CDP frame. Alternatively, or in addition, the CDP frame request can include information requesting a value for at least one communication parameter used for the probe symbol(s) in the CDP frame. Alternatively, or in addition, the CDP frame request can include information requesting a CDP frame where the data symbols and the probe symbols use at least one different communication parameter value. In general, the receiving transceiver 1 can send to the transmitting transceiver 2 a CDP frame request that includes the necessary information for any type of CDP frame construct, with this CDP frame request being transmitted from the receiving transmitter to the transmitting transceiver, in cooperation with the transmitter module 40.

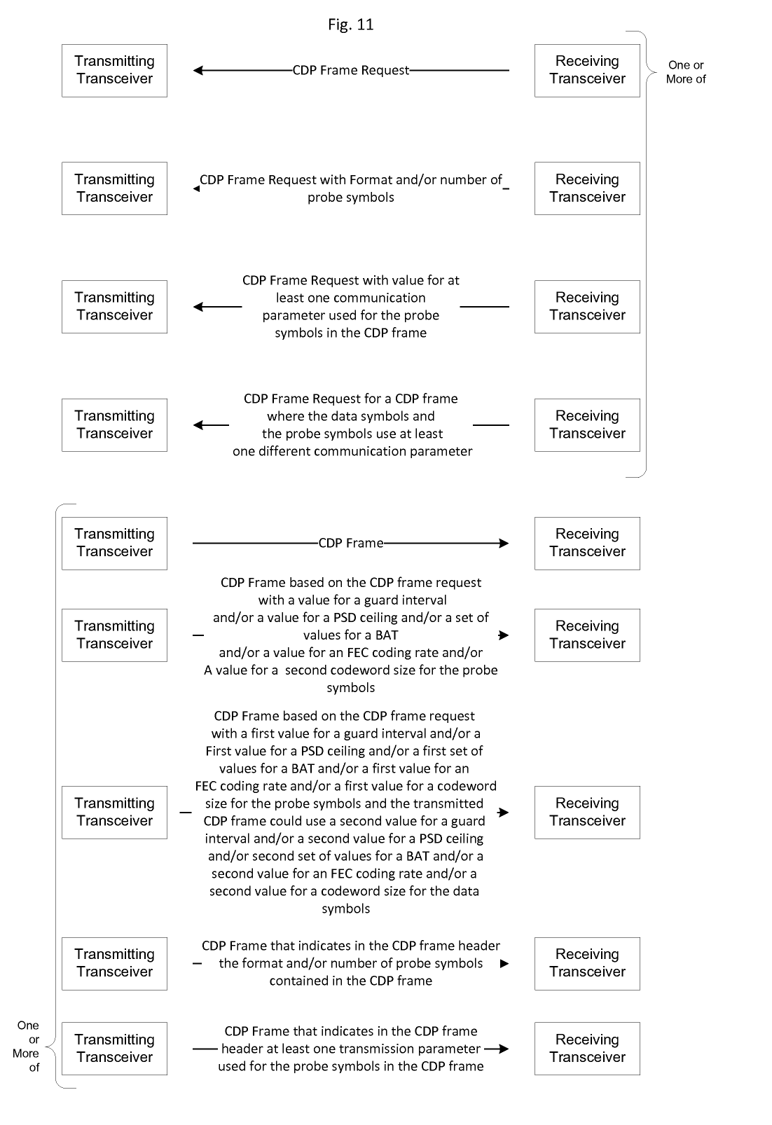

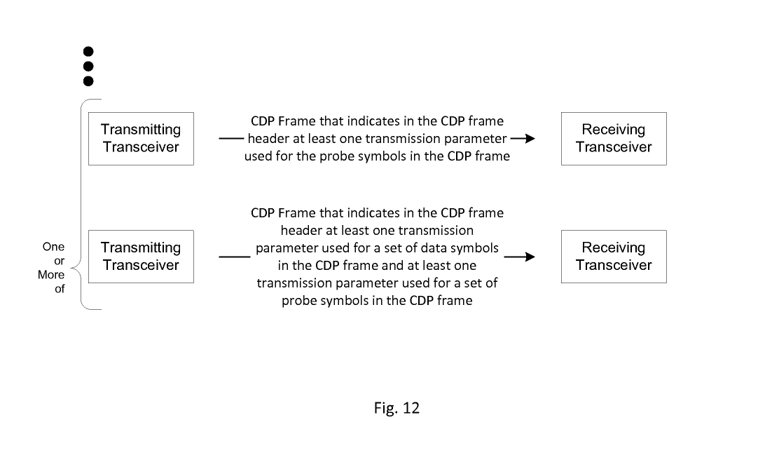

The transmitting transceiver 2, in cooperation with its receiver module, receives the CDP frame request and, in cooperation with its frame determination module, data symbol module and probe frame module, assembles the CDP frame to be returned to the receiving transceiver 1. As illustrated in the exemplary messaging exchanges between a receiving transceiver and a transmitting transceiver in FIGS. 11 and 12, this CDP frame can be based on a CDP frame request with a value for a guard interval and/or a PSD ceiling and/or BAT and/or FEC coding rate and/or second codeword size for the probe symbols.

Alternatively, or in addition, the CDP frame can be based on the CDP frame request with a first value for a guard interval and/or a first value for a PSD ceiling and/or a first set of values for BAT and/or a first value for a FEC coding rate and/or first value for a codeword size for the probe symbols and the transmitted CDP frame could use a second value for a guard interval and/or a second value for a PSD ceiling and/or second set of values for a BAT and/or second set of values for an FEC coding rate and/or second value for a codeword size for the data symbols. At least one of the first values could be different than at least one of the second values. Alternatively, or in addition, the CDP frame could indicate in the CDP frame header the format and/or number of probe symbols contained in the CDP frame.

Alternatively, or in addition, the CDP frame can indicate in the CDP frame header at least one transmission parameter used for the probe symbols in the CDP frame.

Alternatively, or in addition, the CDP frame can indicate in the CDP frame header at least one transmission parameter used for the probe symbols in the CDP frame.

Alternatively, or in addition, the CDP frame can indicate in the CDP frame header at least one transmission parameter used for a set of data symbols in the CDP frame, and at least one transmission parameter used for a set of probe symbols in the CDP frame.

In cooperation with a receiver module 90, frame determination module 10, and one or more of processor 50 and memory 95, the receiving transceiver receives the CDP frame that includes, for example, one or more data frames and one or more probe frames as discussed above. Next, and in cooperation with one or more of the decoder module 20 and channel probing module 80, the transceiver 1 can optionally decode the one or more data symbols and use the one or more probe symbols for channel probing. Further, the transceiver 1 can optionally decode the header to determine information about the data symbols and probe symbols contained in the CDP frame.

The transceiver 1 can also optionally decode the header of the CDP frame to determine a value for the guard interval and/or a PSD ceiling and/or BAT and/or FEC coding rate and/or codeword size for the probe symbols in the CDP frame in cooperation with module 30.

The transceiver can also optionally decode the header to determine the first value for a guard interval and/or a or first value for a PSD ceiling and/or first value for a BAT and/or first value for an FEC coding rate and/or first value for a codeword size for the set of data symbols, and decode the header to determine the second value for a guard interval and/or a second value for a PSD ceiling and/or second value for a BAT and/or second value for an FEC coding rate and/or second value for a codeword size for the set of probe symbols with the cooperation of module 30. At least one of the first values could be different than at least one of the second values.

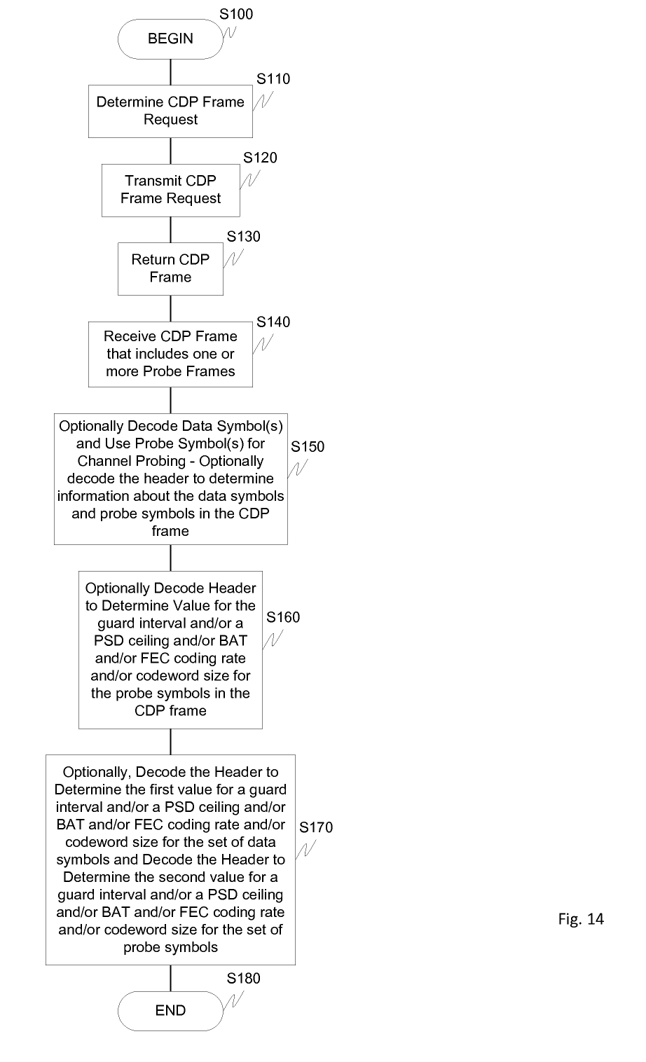

FIG. 14 is a flowchart outlining an exemplary method for determining and using CDP frames. In particular, control begins in step S100 and continues to step S110. In step S110, a CDP frame request is determined by a receiving transceiver. Next, in step S120, the CDP frame request is transmitted from a receiving transceiver to a transmitting transceiver. As described above, a CDP frame request may be done in a number of ways. For example the receiver could request the transmission of a CDP frame by transmitting to the transmitter any available frame type (e.g., probe, data, ACK, ACK+MSG, MSG frames, etc) prior to the transmission of the CPD frame. The CDP frame request could, for example, be indicated in a bit field in the header of a frame transmitted by the receiver to the transmitter prior to the transmission of the CPD frame. Alternatively or in addition, the CDP frame request could be transmitted by the receiver in the information field of a separate management message frame(s) prior to the transmission of the CPD frame.

CDP frame requests may contain any of the information as described herein, such as, for example, the number of probe frames in the CDP frame and/or transmission parameters to be used for those probe frames, etc. Then, in step S130, the transmitting transceiver assembles the requested CDP frame and transmits it to the receiving transceiver using the information as contained in the CDP request. Control then continues to step S140.

In step S140, the CDP frame, originally requested by the receiving transceiver, is received by the receiving transceiver from the transmitting transceiver, the CDP frame including one or more data frames and one or more probe frames, as discussed. Next, in step S150, the transceiver optionally decodes the data symbol(s) and uses the probe symbol(s) contained in the CDP frame for channel probing. Optionally, the transceiver can decode the header to determine information about the data symbols and probe symbols contained in the CDP frame. Control then continues to step S160.

In step S160, the header can optionally be decoded to determine the value for the guard interval and/or a PSD ceiling and/or BAT and/or FEC coding rate and/or codeword size for the probe symbols in the CDP frame. Next, in step S170, the header can optionally be decoded to determine the first value for a guard interval and/or a PSD ceiling and/or BAT and/or FEC coding rate and/or codeword size for the set of data symbols and the header can be decoded to determine the second value for a guard interval and/or a PSD ceiling and/or BAT and/or FEC coding rate and/or codeword size for the set of probe symbols. Control then continues to step S180 where the control sequence ends.

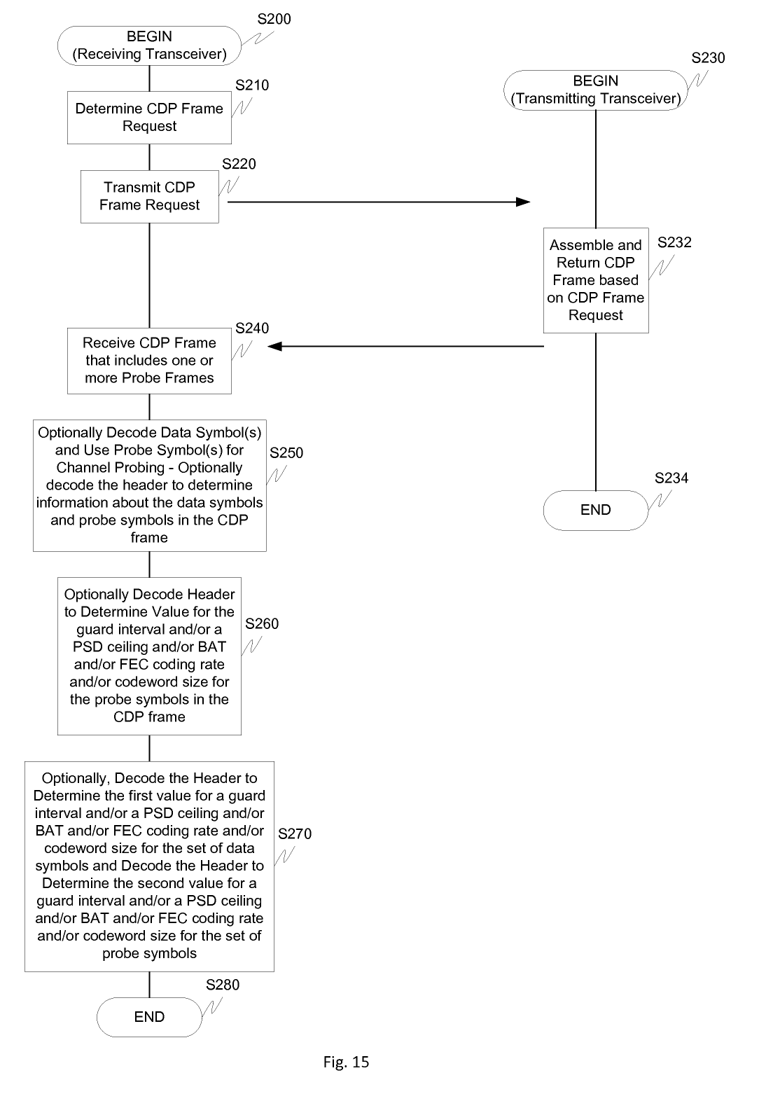

FIG. 15 is a flowchart outlining an exemplary transceiver-centric method for determining and receiving CDP frames. In particular, control for the receiving transceiver begins in step S200 with control for the transmitting transceiver beginning in step S230.

In step S210, the receiving transceiver determines a CDP frame request. Next, in step S220, the CDP frame request is transmitted from the receiving transceiver to the transmitting transceiver. As described above, a CDP frame request may be done in a number of ways. For example the receiver could request the transmission of a CDP frame by transmitting to the transmitter any available frame type (e.g., probe, data, ACK, ACK+MSG, MSG frames, etc) prior to the transmission of the CPD frame. The CDP frame request could, for example, be indicated in a bit field in the header of a frame transmitted by the receiver to the transmitter prior to the transmission of the CPD frame. Alternatively or in addition, the CDP frame request could be transmitted by the receiver in the information field of a separate management message frame(s) prior to the transmission of the CPD frame. As discussed, the CDP frame request may contain any of the information as described herein, such as, for example, the number of probe frames in the CDP frame and/or transmission parameters to be used for the probe frames, etc. Then, in step S232, the transmitting transceiver assembles the requested CDP frame and returns it to the receiving transceiver using the information as contained in the CDP request sent from the receiving transceiver. Control then jumps to step S240 for the receiving transceiver with control continuing to step S234, where the control sequence ends, for the transmitting transceiver.

In step S240, the CDP frame, originally requested by the receiving transceiver, is received by the receiving transceiver from the transmitting transceiver, the CDP frame including one or more data frames and one or more probe frames, as discussed. Next, in step S250, the transceiver optionally decodes the data symbol(s) and uses the probe symbol(s) contained in the CDP frame for channel probing. Optionally, the transceiver can decode the header to determine information about the data symbols and probe symbols contained in the CDP frame. Control then continues to step S260.

In step S260, the header can optionally be decoded to determine the value for the guard interval and/or a PSD ceiling and/or BAT and/or FEC coding rate and/or codeword size for the probe symbols in the CDP frame. Next, in step S170, the header can optionally be decoded to determine the first value for a guard interval and/or a PSD ceiling and/or BAT and/or FEC coding rate and/or codeword size for the set of data symbols and the header can be decoded to determine the second value for a guard interval and/or a PSD ceiling and/or BAT and/or FEC coding rate and/or codeword size for the set of probe symbols. Control then continues to step S280 where the control sequence ends.

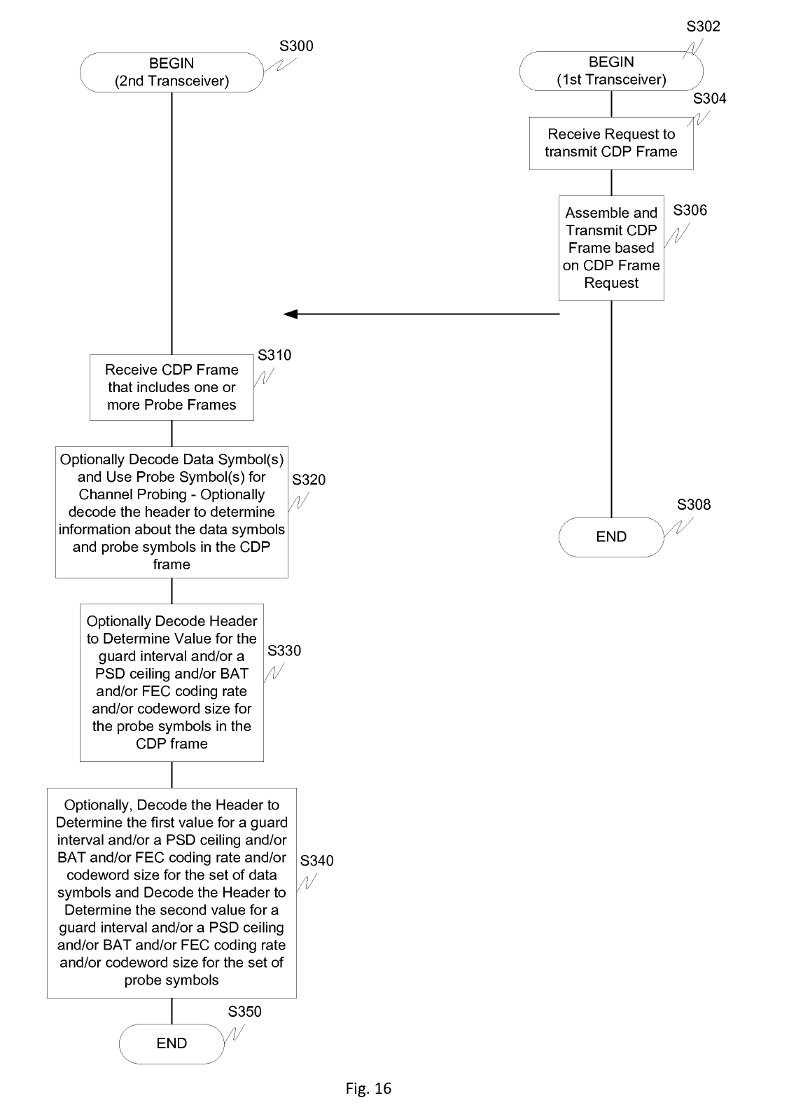

FIG. 16 is a flowchart outlining another exemplary transceiver-centric method using and transmitting CDP frames. Control begins in step S300 for a second transceiver with control beginning in step S302 for a first transceiver, with control continuing to step S304.

In step S304, a request to transmit a CDP frame is received by the first transceiver. This CDP frame request can be receiver from any source, such as another transceiver, a management interface, a diagnostic system, or in general from any location or device. The CDP frame request may contain any of the information as described herein, such as, for example, the number of probe frames in the CDP frame and/or transmission parameters to be used for the probe frames, etc. As described above, a CDP frame request may be done in a number of ways. For example the receiver could request the transmission of a CDP frame by transmitting to the transmitter any available frame type (e.g., probe, data, ACK, ACK+MSG, MSG frames, etc) prior to the transmission of the CPD frame. The CDP frame request could, for example, be indicated in a bit field in the header of a frame transmitted by the receiver to the transmitter prior to the transmission of the CPD frame. Alternatively or in addition, the CDP frame request could be transmitted by the receiver in the information field of a separate management message frame(s) prior to the transmission of the CPD frame. Then, in step S306, the first transceiver assembles the requested CDP frame and transmits it to the second transceiver with control for the first transceiver continuing to step S308 where the control sequence ends.

In step S310, the CDP frame is received by the second transceiver from the first transceiver, the CDP frame including one or more data frames and one or more probe frames, as discussed. Next, in step S320, the second transceiver optionally decodes the data symbol(s) and uses the probe symbol(s) contained in the CDP frame for channel probing. Optionally, the second transceiver can decode the header to determine information about the data symbols and probe symbols contained in the CDP frame. Control then continues to step S330.

In step S330, the header can optionally be decoded by the second transceiver to determine the value for the guard interval and/or a PSD ceiling and/or BAT and/or FEC coding rate and/or codeword size for the probe symbols in the CDP frame. Next, in step S340, the header can optionally be decoded to determine the first value for a guard interval and/or a PSD ceiling and/or BAT and/or FEC coding rate and/or codeword size for the set of data symbols and the header can be decoded to determine the second value for a guard interval and/or a PSD ceiling and/or BAT and/or FEC coding rate and/or codeword size for the set of probe symbols. Control then continues to step S350 where the control sequence ends.

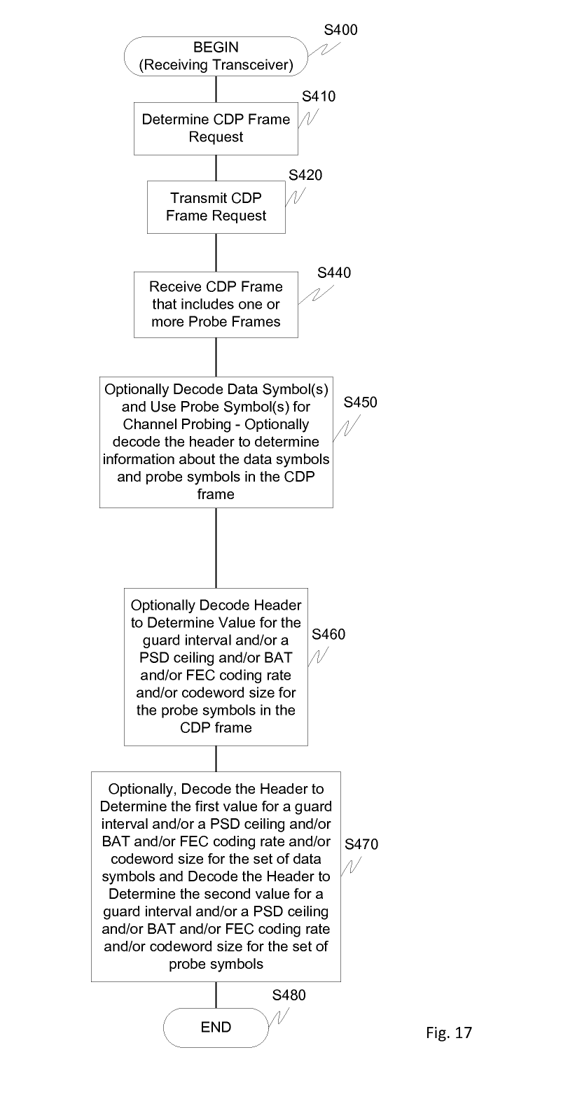

FIG. 17 is a flowchart outlining an exemplary receiving transceiver-centric method for determining and receiving CDP frames. In particular, control for the receiving transceiver begins in step S400. Next, in step S410, the receiving transceiver determines a CDP frame request. Next, in step S420, the CDP frame request is transmitted from the receiving transceiver to a transmitting transceiver. As described above, a CDP frame request may be done in a number of ways. For example the receiver could request the transmission of a CDP frame by transmitting to the transmitter any available frame type (e.g., probe, data, ACK, ACK+MSG, MSG frames, etc) prior to the transmission of the CPD frame. The CDP frame request could, for example, be indicated in a bit field in the header of a frame transmitted by the receiver to the transmitter prior to the transmission of the CPD frame. Alternatively or in addition, the CDP frame request could be transmitted by the receiver in the information field of a separate management message frame(s) prior to the transmission of the CPD frame. As discussed, the CDP frame request may contain any of the information as described herein, such as, for example, the number of probe frames in the CDP frame and/or transmission parameters to be used for the probe frames, etc.

Then, in step S440, the CDP frame, originally requested by the receiving transceiver, is received by the receiving transceiver from the transmitting transceiver, the CDP frame including one or more data frames and one or more probe frames, as discussed. Next, in step S450, the transceiver optionally decodes the data symbol(s) and uses the probe symbol(s) contained in the CDP frame for channel probing. Optionally, the receiving transceiver can decode the header to determine information about the data symbols and probe symbols contained in the CDP frame. Control then continues to step S460.

In step S460, the header can optionally be decoded to determine the value for the guard interval and/or a PSD ceiling and/or BAT and/or FEC coding rate and/or codeword size for the probe symbols in the CDP frame. Next, in step S470, the header can optionally be decoded to determine the first value for a guard interval and/or a PSD ceiling and/or BAT and/or FEC coding rate and/or codeword size for the set of data symbols and the header can be decoded to determine the second value for a guard interval and/or a PSD ceiling and/or BAT and/or FEC coding rate and/or codeword size for the set of probe symbols. Control then continues to step S480 where the control sequence ends.

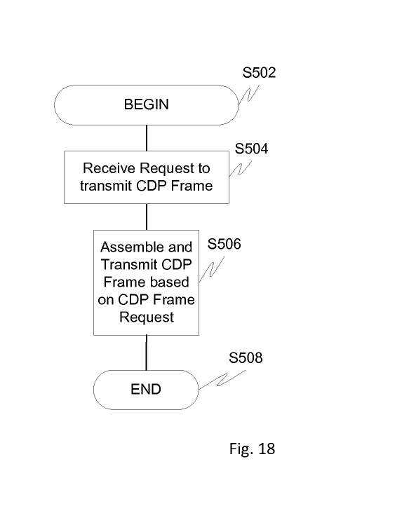

FIG. 18 is a flowchart outlining another exemplary transceiver-centric method for assembling and transmitting CDP frame(s). Control begins in step S502 for the transceiver, with control continuing to step S504.

In step S504, a request to transmit a CDP frame is received by the transceiver. This CDP frame request can be receiver from any source, such as another transceiver, a management interface, a diagnostic system, or in general from any location or device. The CDP frame request may contain any of the information as described herein, such as, for example, the number of probe frames in the CDP frame and/or transmission parameters to be used for the probe frames, etc. As described above, a CDP frame request may be done in a number of ways. For example the receiver could request the transmission of a CDP frame by transmitting to the transmitter any available frame type (e.g., probe, data, ACK, ACK+MSG, MSG frames, etc) prior to the transmission of the CPD frame. The CDP frame request could, for example, be indicated in a bit field in the header of a frame transmitted by the receiver to the transmitter prior to the transmission of the CPD frame. Alternatively or in addition, the CDP frame request could be transmitted by the receiver in the information field of a separate management message frame(s) prior to the transmission of the CPD frame. Then, in step S506, the transceiver assembles the requested CDP frame and transmits it to another transceiver with control for the transceiver continuing to step S508 where the control sequence ends.

In accordance with another exemplary embodiment, the use of probe frames can be used to assist with performing interference mitigation. More specifically, there may be situations in which predictable interferences exist in a communications environment. These predictable interferences can include, but are not limited to, crosstalk, AM ingress, FM radio, narrow-band interference, light dimmers, consumer electronics devices, hand-held radios, telephones, other DSL services on the same line or in the same bundle, other electronics equipment, and in general can include any type of device that may cause one or more of predictable and periodic interference.

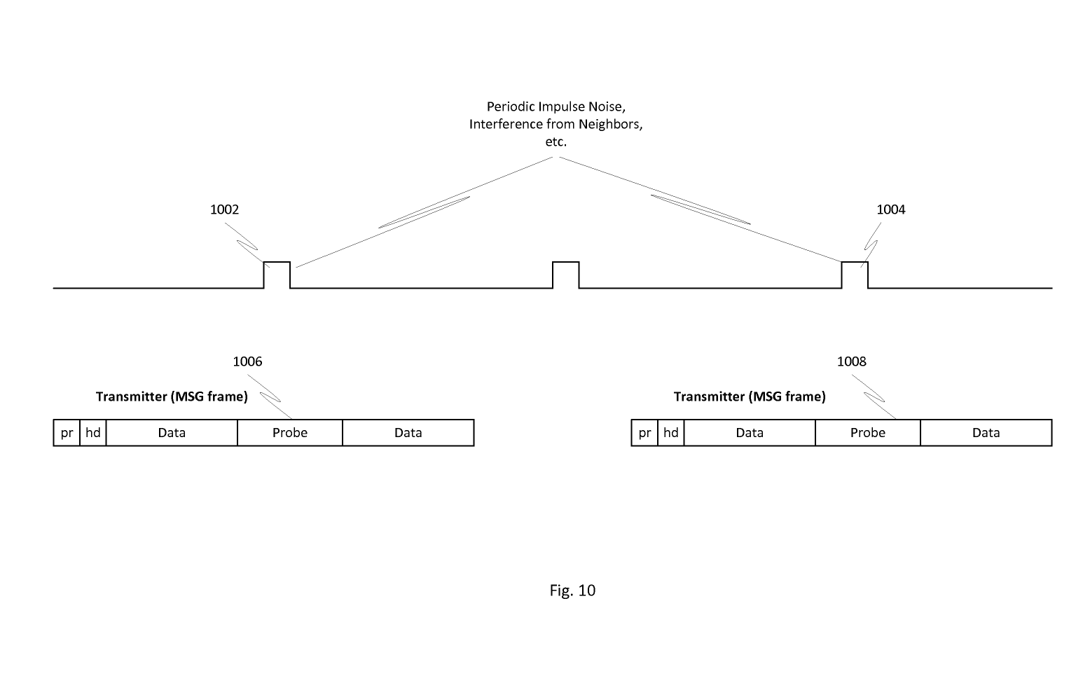

In situations such as these, the probe symbols can also be used in a CDP frame to assist with protecting data symbols in that the probe symbols can be utilized or treated as dummy symbols. For example, and as illustrated in FIG. 10, there are three periodic noise impulses, with two of the three periodic noise impulses 1002 and 1004 occurring roughly at the same time as probe frames 1006 and 1008, respectively. In accordance with one exemplary embodiment, the transceiver can include an interference detection module 92 that is capable of tracking, monitoring, and optionally predicting when inferences are going to occur. This can be used, in cooperation with the frame determination module 10, controller 50 and memory 95 to determine a frame whose probe symbols are placed coincident with the interference as illustrated in FIG. 10.

As used herein the terms network and domain have the same meaning and are used interchangeably. Also, the terms receiver, receiving node and receiving transceiver have the same meaning and are used interchangeably. Similarly, the terms transmitter, transmitting node and transmitting transceiver have the same meaning and are used interchangeably. The terms transceiver and modem also have the same meaning and are used interchangeably. While the term home network has been used in this description, the description is not limited to home networks but in fact applies also to any network, such as enterprise networks, business networks, or any network with a plurality of connected nodes. The terms frame and packet have the same meaning and are used interchangeably in the description. The term header and PHY-frame header have the same meaning and are used interchangeably in the description

While the above-described methods and systems can be described with respect to a port (or endpoint) in a network, they can also be implemented in a dedicated module such as a test or network optimization module. This dedicated module could be plugged into the network and act as a Domain Master or with the cooperation of the Domain Master could initiate the various measurement techniques, gather the measurements from the port(s) in the network, analyze the measurements and use the measured information to detect and diagnose problems in the network and/or to optimize or improve the performance of a network.

The above-described methods and systems and can be implemented in a software module, a software and/or hardware testing module, a telecommunications test device, a linecard, a G.hn transceiver, a MOCA transceiver, a Homeplug® transceiver, a powerline modem, a wired or wireless modem, test equipment, a multicarrier transceiver, a wired and/or wireless wide/local area network system, a satellite communication system, network-based communication systems, such as an IP, Ethernet or ATM system, a modem equipped with diagnostic capabilities, or the like, or on a separate programmed general purpose computer having a communications device or in conjunction with any of the following communications protocols: MOCA, G.hn, Homeplug® or the like.

Additionally, the systems, methods and protocols of this invention can be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a modem, a transmitter/receiver, any comparable means, or the like. In general, any device (or one or more equivalent means) capable of implementing a state machine that is in turn capable of implementing the methodology illustrated herein can be used to implement the various communication/measurement methods, protocols and techniques according to this invention.

Furthermore, the disclosed methods may be readily implemented in software stored on a non-transitory computer-readable storage media using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software that can be stored on a computer-readable storage medium, executed on programmed general-purpose computer with the cooperation of a controller and memory, a special purpose computer, a microprocessor, or the like. The systems and methods of this invention can be implemented as a program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a test/modem device.

While the invention is described in terms of exemplary embodiments, it should be appreciated that individual aspects of the invention could be separately claimed and one or more of the features of the various embodiments can be combined.

While the exemplary embodiments illustrated herein discuss the various components collocated, it is to be appreciated that the various components of the system can be located a distant portions of a distributed network, such as a telecommunications network and/or the Internet or within a dedicated communications network. Thus, it should be appreciated that the components of the system can be combined into one or more devices or collocated on a particular node of a distributed network, such as a telecommunications network. As will be appreciated from the following description, and for reasons of computational efficiency, the components of the communications network can be arranged at any location within the distributed network without affecting the operation of the system.

It is therefore apparent that there has been provided, in accordance with the present invention, systems and methods for combining data and probe frames. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. An OFDM communication method comprising:
transmitting, by a transmitter, or receiving, by a receiver, a frame comprising:
one or more preamble symbols;
one or more header symbols;
a plurality of data symbols; and
a plurality of probe symbols, wherein the probe symbols are predefined symbols that do not carry user data and are generated by modulating a predefined pseudo-random bit sequence (PRBS),
wherein a frame header, communicated in the one or more header symbols, includes one or more bit fields that indicate a number of probe symbols, N, wherein N is an integer greater than 1, and
wherein the plurality of probe symbols are transmitted or received after the one or more header symbols.

2.-4. (canceled)

5. The method of claim 1, wherein the plurality of probe symbols are transmitted or received after the one or more data symbols.

6. The method of claim 1, wherein the one or more data symbols are transmitted or received after the plurality of probe symbols.

7. The method of claim 1, wherein at least one data symbol uses a different communication parameter value than at least one of the plurality of probe symbols.

8. The method of claim 1, wherein at least one data symbol uses a first guard interval value and at least one probe symbol uses a second, different, guard interval value.

9. The method of claim 1, wherein at least one data symbol uses a first PSD ceiling value and at least one probe symbol uses a second, different, PSD ceiling value.

10. The method of claim 1, wherein at least one data symbol uses a first bit allocation table and at least one probe symbol uses a second, different, bit allocation table.

11. The method of claim 1, wherein a frame header of the CDP frame contains one or more bit fields that indicate that the CDP frame contains one or more data symbols and one or more probe symbols.

12. The method of claim 1, wherein a frame header of the CDP frame contains one or more bit fields that indicate that the probe symbols are received or transmitted after the data symbols.

13. The method of claim 1, wherein a frame header of the CDP frame contains one or more bit fields that indicate that the CDP frame contains N probe symbols, wherein N is an integer and M data symbols, where M is an integer.

14. The method of claim 1, wherein the transmitter includes an ASIC.

15. The method of claim 1, wherein the transmitter includes a digital signal processor.

16. The method of claim 1, wherein the receiver includes a digital signal processor.

17. The method of claim 1, wherein a frame header contains one or more bit fields that indicate that there is one or more probe symbols after every Kth data symbol, where K is an integer

18.-31. (canceled)

32. An OFDM system comprising:
means for transmitting and/or means for receiving a frame comprising:
one or more preamble symbols;
one or more header symbols;
a plurality of data symbols; and
a plurality of probe symbols, wherein the probe symbols are predefined symbols that do not carry user data and are generated by modulating a predefined pseudo-random bit sequence (PRBS),
wherein a frame header, communicated in the one or more header symbols, includes one or more bit fields that indicate a number of probe symbols, N, wherein N is an integer greater than 1, and
wherein the plurality of probe symbols are transmitted or received after the one or more header symbols.

33.-61. (canceled)

62. An OFDM transceiver comprising:
a transmitter that is capable of transmitting and/or a receiver that is capable of receiving a frame comprising:
one or more preamble symbols;
one or more header symbols;
a plurality of data symbols; and
a plurality of probe symbols, wherein the probe symbols are predefined symbols that do not carry user data and are generated by modulating a predefined pseudo-random bit sequence (PRBS),
wherein a frame header, communicated in the one or more header symbols, includes one or more bit fields that indicate the number of probe symbols, N, wherein N is an integer greater than 1, and
wherein the plurality of probe symbols are transmitted or received after the one or more header symbols.

63.-65. (canceled)

66. The transceiver of claim 62, wherein the plurality of probe symbols are transmitted or received after the one or more data symbols.

67. The transceiver of claim 62, wherein the one or more data symbols are transmitted or received after the plurality of probe symbols.

68. The transceiver of claim 62, wherein at least one data symbol uses a different communication parameter value than at least one of the plurality of probe symbols.

69. The transceiver of claim 62, wherein at least one data symbol uses a first guard interval value and at least one probe symbol uses a second, different, guard interval value.

70. The transceiver of claim 62, wherein at least one data symbol uses a first PSD ceiling value and at least one probe symbol uses a second, different, PSD ceiling value.

71. The transceiver of claim 62, wherein at least one data symbol uses a first bit allocation table and at least one probe symbol uses a second, different, bit allocation table.

72. The transceiver of claim 62, wherein a frame header of the CDP frame contains one or more bit fields that indicate that the CDP frame contains one or more data symbols and one or more probe symbols.

73. The transceiver of claim 62, wherein a frame header of the CDP frame contains one or more bit fields that indicate that the probe symbols are received or transmitted after the data symbols.

74. The transceiver of claim 62, wherein a frame header of the CDP frame contains one or more bit fields that indicate that the CDP frame contains M data symbols, where M is an integer.

75. The transceiver of claim 62, wherein a frame header contains one or more bit fields that indicate that the probe symbols are transmitted or received after the data symbols.

76.-92. (canceled)

93. The transceiver of claim 62, wherein the transceiver includes an ASIC.

94. The transceiver of claim 62, wherein the transceiver includes a digital signal processor.

95. A non-transitory computer readable information storage media having stored thereon instructions, that if executed by a processor, cause the processor to perform a method comprising:
transmitting, by a transmitter, or receiving, by a receiver, a frame comprising:
one or more preamble symbols;
one or more header symbols;
a plurality of data symbols; and
a plurality of probe symbols, wherein the probe symbols are predefined symbols that do not carry user data and are generated by modulating a predefined pseudo-random bit sequence (PRBS),
wherein a frame header, communicated in the one or more header symbols, includes one or more bit fields that indicate a number of probe symbols, N, wherein N is an integer greater than 1, and
wherein the plurality of probe symbols are transmitted or received after the one or more header symbols.
